(19) United States
(12) Patent Application Publication
(10) Pub. No.: US 2016/0311139 A1
(43) Pub. Date: Oct. 27, 2016

(54) METHOD FOR PRODUCING A SPONGE MADE OF POLYURETHANE FOAM CONTAINING COPPER NANOPARTICLES AS A BACTERICIDAL AND FUNGICIDAL ADDITIVE

(71) Applicant: VIRUTEX ILKO S.A., Santiago (CL)

(72) Inventor: Vittorio TAMAGNINI, Santiago (CL)

(21) Appl. No.: 15/030,801

(22) PCT Filed: Sep. 16, 2014
(86) PCT No.: PCT/CL2014/000047

§ 371 Date: Apr. 20, 2016

(30) Foreign Application Priority Data
Jan. 17, 2014 (CL) 139-2014

(51) Int. Cl. B29C 44/02; C08G 18/48; C08J 9/12; C08G 18/18; C08G 18/24; C08G 18/76; C08G 18/20

(52) U.S. Cl. CPC B29C 44/02; C08G 18/7621; C08G 18/48; C08G 18/2081; C08G 18/1833; C08G 18/244; C08J 9/125; C08G 2101/0083

(57) ABSTRACT

A process for the preparation of sponges made of polyurethane foam with high absorption capacity and modified toxicity level, to which copper nanoparticles are added to ensure their antibacterial capability.

The present invention relates to a process for the production of sponges made with polyurethane foam, whose toxicity and antibacterial properties have been modified by adding an antibacterial compound based on copper nanoparticles.

### BACKGROUND OF THE INVENTION

Solid materials capable of absorbing an amount of water and/or aqueous fluids have been used for a long time according to various applications found in the prior art.

To this end, natural sponges have been used in various applications in which the quality of absorption of a significant amount of liquid in relation to their size and weight was necessary. However, natural sponges have long been replaced by synthetic sponges. Synthetic sponges offer various advantages in that, among others, they are in steady supply, they can be produced in various sizes and shapes according to their application, and their cost is low. These synthetic sponges can be produced from a variety of polymeric materials which include vinyl, viscose, cellulose, rubber, and polyurethane, among others.

A sponge is a tool used, among other applications, for body hygiene or for cleaning other surfaces, due to its capacity to absorb water or other liquids.

The sponge is a porous material that can be made from cellulosic fibers or plastic polymers (usually polyurethane). There are, as was previously indicated, natural sponges, used in hygiene activities, although primarily used for facial or body cleansing.

Sponges found in the bathroom are used to distribute the soap on the body during ordinary hygiene activities. In addition, they can be used for washing dishes or utensils when consisting, in some cases, in a combination sponge and scouring pad which may be used interchangeably.

The present invention relates to sponges made of polyurethane, which was discovered and patented in 1937 in Imperial Patent No. DRP-728.981 of Nov. 13, 1937, in the name of Otto Bayer.

Since its discovery 76 years ago, other methods for preparing polyurethane were found, namely when Bayer patented the Moltopren© in 1952 and the Desmopan© in 1955, among the many patents related to polyurethane, such as British Patent Application UK 20130276352, U.S. Pat. No. 4,985,467 granted to D. Kelly et al., and U.S. Pat. No. 6,136,878 granted to Sharon Free et al.

Polyurethane foams are usually prepared by reacting polyisocyanate with a poly-hydroxy compound in the presence of water, which acts as a bubbling or blowing agent. Water reacts with the isocyanate groups, releasing carbon dioxide CO2, which forms the cells or trapped bubbles once the polyurethane has cured.

In addition to the above-mentioned patents, the following patent related to the preparation of polyurethane foam, U.S. Pat. No. 4,104,435 from J. C. Ballestero et al. discloses a synthetic sponge comprising a resilient foam material. Also, U.S. Pat. No. 4,717,738 from Masao Fukuda et al. describes a resin-based polyurethane with a hydroxyl containing a polyol polymer. U.S. Pat. No. 4,725,629 from Chad Garvey discloses a superabsorbent polyurethane foam made of a polymer network interconnected with a crosslinked polyurethane and a crosslinked polymer which contains a plurality of chain segments, formed by functional groups containing repeating units which may be identical or different.

### DESCRIPTION OF THE INVENTION

A large number of patents awarded in the prior art describe changes in the preparation of polyurethane foam for its various applications in which the material must take into account exceptional conditions, such as bactericides, fungicides, anti-rust, along with a low toxicity, for which the prior art has used compounds and substances such as dimethylhydantoin, quaternary ammonium compounds, bis(2-(dimethylamino)ethyl) ether, silver-containing zeolite, hetero oils or phenols, chlorophenol and isothiazole, compounds for the dissociation of formaldehyde such as dimethylol-hydantoin or copper or zinc salts, all compounds having, as indicated, bactericide, fungicide, fire retardant and/or anti-mildew properties, among others.

Most of the previously mentioned compounds are highly toxic to humans and difficult to handle during preparation of the polyurethane foam, considering the large quantities required, most of them requiring special attention and procedures for handling.

The present invention solves the problem previously cited through the use of “copper nanoparticles” acting as bactericidal and fungicidal agents, which are safe to humans, thereby simplifying the preparation of the polyurethane foam containing said copper nanoparticles.

For the present invention, the preparation of the foam base, for both sponges and other products mentioned, does not involve great differences with the modalities used in the prior art. Such foam is prepared from a mixture of a high molecular weight poly-alcohol to which toluene diisocyanate (DIT) and water are added. The mixture is performed in the presence of amine, metal and silicon catalysts in small quantities.

Soluble dyes are added to the mixture for certain types of foams during production.

Some foams require certain physical characteristics, such as high strength, which are achieved through the use of various types of basic polyol and catalysts thereof, such as amines or special silicones.

The final product obtained is stable, flexible, resilient, non-toxic polyurethane foam suitable to be thinly laminated for use in mattresses, quilts, footwear, seat upholstery, insulation, impact protection and which can be cut into smaller sizes to produce sponges, etc.

The foam is subjected to a treatment with a flame retardant, as its name implies, making it difficult to burn and resistant to lit cigarettes or matches, etc., without burning.

### DETAILED DESCRIPTION OF THE INVENTION

The elements forming part of the composition of the foam are described below and are further detailed in Table 1 of the present Specifications:

I) Polyol: Long-chain polyether alcohol as primary reagent, whose OH radicals bind to TDI (toluene diisocyanate) to form the foam.

II) Reactive 2,4- and 2,6-toluene diisocyanate TDI (80:20), whose CN groups bind to the polyol to form the foam.

III) Water, which reacts with TDI and, as a blowing agent, emits CO2 gas, which forms bubbles necessary to shape the cell structure or the cells in the foam.

IV) Silicone: the polydimethylsiloxane, a nonhydrolyzable surfactant, lowers the surface tension of the polyol, improving its ability to react; it further increases the strength of the cell walls, preventing the foam from collapsing.

V) Amine: 33 wt % triethylenediamine in polypropylene glycol acts as a catalyst in the reaction between the TDI and water.

VI) Amine: 70 wt % bis(dimethylaminoethyl) ether in dipropylene glycol acts as a catalyst for the reaction.

VII) Tin octoate: 2-Ethylhexanoic acid tin (II) salt acts as a catalyst in the reaction between the polyol and TDI, reaction known as foam gelation.

VIII) Dyes: Dyes soluble in polyol dye the foam different colors without affecting its chemical composition.

IX) Additives: Bactericides, copper nanoparticles, as well as antifungal and flame retardants can be added.

TABLE 1

| Raw material | Type | Formula | kg/min. | Block |
|---|---|---|---|---|
| Polyol | — | 99.50 | 146.51 | 27.221 |
| TDI | 1.130 | 53.507 | 78.66 | 14.613 |
| Water | — | 4.000 | 5.88 | 1.092 |
| Amine I | Machine | 0.400 | 0.588 | 109.2 |
| Silicone | L-603 | 0.840 | 1.235 | 229.4 |
| Octoate I | Machine | 0.260 | 0.382 | 71.01 |
| Yellow pigment | Miraphane C | 1.76045 | 2.588 | 480.80 |
| Orange dye | Milliken | 0.00617 | 0.009 | 1.684 |
| Additives: | — | 0.220 | 0.323 | 60.08 |
| Antibacterial | | | | |
| copper | | | | |
| nanoparticles | | | | |

Density 21 ANC

Elaboration Process

There are two methods for manufacturing the foam in factory, namely:

Continuous process with automatic dosing in forming, pre-mixing machine;

Batch process using reactor and molds, with manual dosage.

While the process for producing foam is well known in the prior art, only one of the methods will be described, which produces a foam block weighing approximately 270 kilograms. The description of the continuous manufacturing process is as follows:

Raw materials or components in reservoirs or tanks fitted with their respective pumps are delivered through pipes to the mixing machine according to a preset dosing.

The foam in formation passes from the mixer to an accumulation and distribution tray, then to the tunnel for growth and expansion.

Said tunnel comprises walls and floor covered with Kraft paper coated with a polyethylene film. Furthermore, the floor of the tunnel moves at a pre-established dosing speed while receiving the compounds of the mixture. Then, once the mixture thereof is completed and a block of foam, which weighs approximately 270 kilograms, is formed, this block is transported in one piece up to a cutter or guillotine.

Upon reaching the cutter or guillotine, the foam is firm enough to be cut in the required pre-set sizes to form sponges.

The cut foam is then sent to the “curing” yards by means of specially fitted cranes to be subjected to a “curing” process lasting approximately 24 hours. After this curing, the foam is ready for storage and sale.

1. A process for the preparation of sponges made of polyurethane foam with high absorbency and a modified level of toxicity, wherein, in order to ensure their antibacterial capabilities, copper nanoparticles are added and their preparation includes the following compounds:
I) Polyol: long-chain polyether alcohol;
II) 2,4- and 2,6-toluene diisocyanate TDI (80:20), as a reagent;
III) Water reacting with TDI, as a blowing agent;
IV) Silicone: Polydimethylsiloxane, nonhydrolyzable, as a surfactant;
V) Amine: 33 wt % triethylenediamine in polypropylene glycol, as a catalyst;
VI) Amine: 70 wt % bis(dimethylaminoethyl) ether in dipropylene glycol, as a catalyst;
VII) Tin octoate: 2-Ethylhexanoic acid tin (II) salt, as a catalyst;
VIII) Dyes: Dyes soluble in polyol; and
IX) Additives: Bactericides, fungicides and bactericides.

2. The process for the preparation of sponges made of polyurethane foam with copper nanoparticles according to claim 1, wherein the compounds are mixed in a machine comprising a tunnel which has walls and a floor covered with Kraft paper coated with a polyethylene film. Furthermore, the floor of the tunnel advances at a pre-established dosing speed while receiving the compounds of the mixture, then, once the mixture thereof is completed and a foam block, which weighs approximately 270 kilograms, is formed, said block is transported in one piece up to a cutter or guillotine.

3. The process for the preparation of sponges made of polyurethane foam with copper nanoparticles according to claim 1, wherein the compounds of the mixture are:
I) Polyol at a rate of 146.51 kg/minute;
II) TDI is added at a rate of 78.66 kg/min.;
III) Water is added at a rate of 5.88 kg/min.;
IV) Amine I is added at a rate of 0.588 kg/min.;
V) L603 silicone is added at a rate of 1.235 kg/min.;
VI) Octoate I is added at a rate of 0.382 kg/min.;
VII) Yellow pigment is added at a rate of 2.588 kg/min.;
VIII) Orange dye is added at a rate of 0.009 kg/min.; and
IX) Bactericide and/or germicide are added at a rate of 0.323 kg/min.
A foam block weighing 270 kilograms is thus obtained.

4. The process for the preparation of sponges made of polyurethane foam with copper nanoparticles according to claim 1, wherein the bactericide and/or germicide are copper nanoparticles which are added at a rate of 0.323 kg per minute of tunnel advance.

5. The process for the preparation of sponges made of polyurethane foam with copper nanoparticles according to claim 1, wherein, once the mixture exits the mixer, it then moves to an accumulation and distribution tray, then on to a growth and expansion tunnel whose side walls and floor are covered with Kraft paper coated with a polyethylene film.

6. The process for the preparation of sponges made of polyurethane foam with copper nanoparticles according to claim 1, wherein the foam inside the expansion tunnel moves as a single block according to the design of the tunnel, up to a guillotine or cutter.

7. The process for the preparation of sponges made of polyurethane foam with copper nanoparticles according to claim 1, wherein the guillotine or cutter cuts the block foam into the predetermined sizes of sponges, which are then subjected to a curing process for 24 hours.

8. The process for the preparation of sponges made of polyurethane foam with copper nanoparticles according to claim 1, wherein, once curing of the sponges is completed, these sponges are ready to be packaged and sold.
